(19) United States
(12) Patent Application Publication
(10) Pub. No.: US 2026/0252633 A1
(43) Pub. Date: Aug. 27, 2026

(54) CHIP BINNING SYSTEM AND METHOD

(71) Applicant: DigWise Technology Corporation, LTD, Hsinchu County (TW)

(72) Inventors: Sheng-Kuan YU, Hsinchu County (TW); Che-Shien LIN, Hsinchu County (TW)

(21) Appl. No.: 19/224,929

(22) Filed: Jun. 2, 2025

(30) Foreign Application Priority Data
Feb. 24, 2025 (TW) 114106773

(51) Int. Cl. G06F 16/906

(52) U.S. Cl. CPC G06F 16/906

(57) ABSTRACT

A chip binning system includes a chip analysis database and a chip binning server communicatively connected to each other. The chip binning server includes a feature generation module, a first binning module, a second binning module, and a bin reduction module. The feature generation module generates chip feature data according to the chip analysis data. The first binning module generates chip performance levels according to the chip feature data, and performs a first binning on the chips according to the chip performance levels to generate first binning data. The second binning module performs a second binning on the chips in each bin in the first binning data according to chip power levels in the chip analysis data to generate second binning data. The bin reduction module performs a binning reduction on a number of bins in the second bin data to generate third binning data.

### RELATED APPLICATIONS

This application claims priority to Taiwan Application Serial Number 114106773, filed Feb. 24, 2025, which is herein incorporated by reference.

### BACKGROUND

### Technical Field

The present disclosure relates to a chip binning system and method, and more particularly to a chip binning system and method for multiple binning.

### Description of Related Art

When binning chips, clustering algorithms such as K-means algorithm are often used for performing clustering based on the feature data of the chips, which is achieved by minimizing the variation within the group. However, when processing the chip feature data, it is difficult to effectively control and consider the impact of power changes, and when assuming that all groups are similar, it is difficult to distinguish small differences or anomalies between chips. Therefore, a chip binning method is needed that can consider the impact of chip power and distinguish small differences to improve the efficiency and accuracy of chip binning.

### SUMMARY

One aspect of the present disclosure directs to a chip binning system, including a chip analysis database and a chip binning server. The chip analysis database is configured to store chip analysis data corresponding to chips. The chip binning server is communicatively connected to the chip analysis database to receive the chip analysis data. The chip binning server includes a feature generation module, a first binning module, a second binning module, and a bin reduction module. The feature generation module is configured to generate corresponding chip feature data according to the chip analysis data. The first binning module is configured to generate corresponding chip performance levels according to the corresponding chip feature data, and perform a first binning on the chips according to the chip performance levels to generate first binning data. The second binning module is configured to perform a second binning on the chips in each bin in the first binning data according to corresponding chip power levels in the chip analysis data to generate second binning data. The bin reduction module is configured to perform a binning reduction on a number of bins in the second bin data to generate third binning data.

In accordance with some embodiments, the first binning module is further configured to perform a re-binning on the chips not binned by the first binning and the second binning.

In accordance with some embodiments, the chip binning system further includes a binning analysis server. The binning analysis server is communicatively connected to the chip binning server and configured to receive the third binning data and the chip analysis data corresponding to the chips in the third binning data for building a chip binning model accordingly. The chip binning model is used for binning other chips different from the chips according to the corresponding chip analysis data to generate fourth binning data.

In accordance with some embodiments, each of the other chips in the fourth data corresponding to at least one of bins in the third binning data.

In accordance with some embodiments, the first binning is to bin a preset ratio of the chips with better chip performance levels according to the corresponding chip performance levels, and generate the first binning data.

In accordance with some embodiments, the first binning is to select at least one binning center chip from the chips according to the corresponding chip performance levels, bin the chips according to whether chip performance distances between the chips and the at least one binning center chip are smaller than a preset performance distance, and generate the first binning data.

In accordance with some embodiments, the first binning module is further configured to perform a re-binning on the chips not binned by the first binning and the second binning, and the preset performance distance in the re-binning is greater than the previous binning.

In accordance with some embodiments, in the second binning data generated by the second binning module, a power standard deviation of the chips in each bin is smaller or equal to a preset standard deviation.

Another aspect of the present disclosure directs to a chip binning method, including: generating corresponding chip feature data according to chip analysis data corresponding to chips; generating corresponding chip performance levels according to the corresponding chip feature data, and performing a first binning on the chips according to the chip performance levels to generate first binning data; performing a second binning on the chips in each bin in the first binning data according to corresponding chip power levels in the chip analysis data to generate second binning data; and performing a binning reduction on a number of bins in the second bin data to generate third binning data.

In accordance with some embodiments, the chip binning method further includes performing a re-binning on the chips not binned by the first binning and the second binning.

In accordance with some embodiments, the chip binning method further includes building a chip binning model according to the third binning data and the chip analysis data corresponding to the chips in the third binning data. The chip binning model is used for binning other chips different from the chips according to the corresponding chip analysis data to generate fourth binning data.

In accordance with some embodiments, each of the other chips in the fourth data corresponding to at least one of bins in the third binning data.

In accordance with some embodiments, the first binning is to bin a preset ratio of the chips with better chip performance levels according to the corresponding chip performance levels, and generate the first binning data.

In accordance with some embodiments, the first binning is to select at least one bin center chip from the chips according to the corresponding chip performance levels, bin the chips according to whether chip performance distances between the chips and the at least one bin center chip are smaller than a preset performance distance, and generate the first binning data.

In accordance with some embodiments, the chip binning method further includes performing a re-binning on the chips not binned by the first binning and the second binning, and the preset performance distance in the re-binning is greater than the previous binning.

In accordance with some embodiments, in the second binning data generated by the second binning, a power standard deviation of the chips in each bin is smaller or equal to a preset standard deviation.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a chip binning system in accordance with some embodiments of the present disclosure.

FIG. 2 is a flowchart of a chip binning method in accordance with some embodiments of the present disclosure.

FIG. 3 is a schematic diagram of a binning performance comparison of a chip binning method and K-means algorithm in accordance with some embodiments of the present disclosure.

### DETAILED DESCRIPTION

The detailed explanation of the present disclosure is described as following. The described preferred embodiments are presented for purposes of illustrations and description, and they are not intended to limit the scope of the present disclosure.

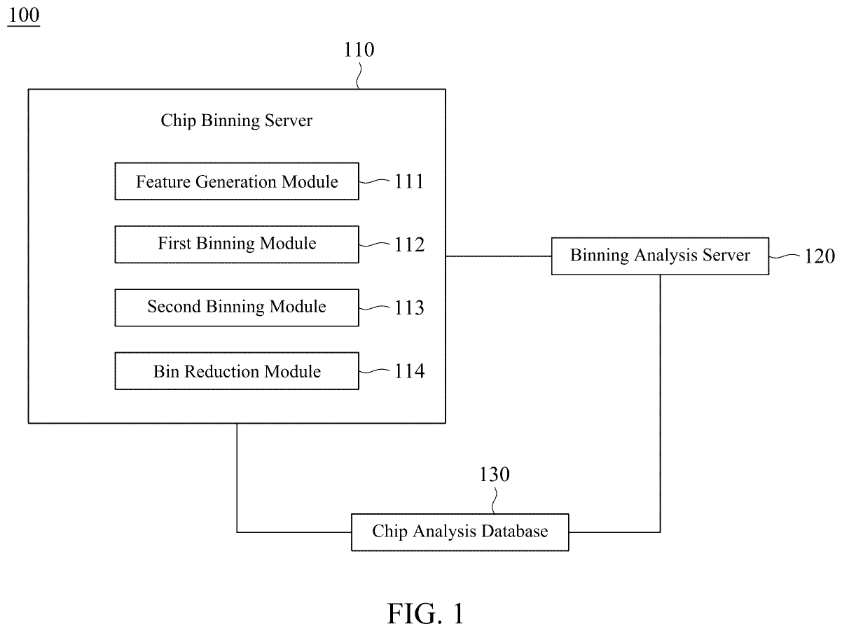

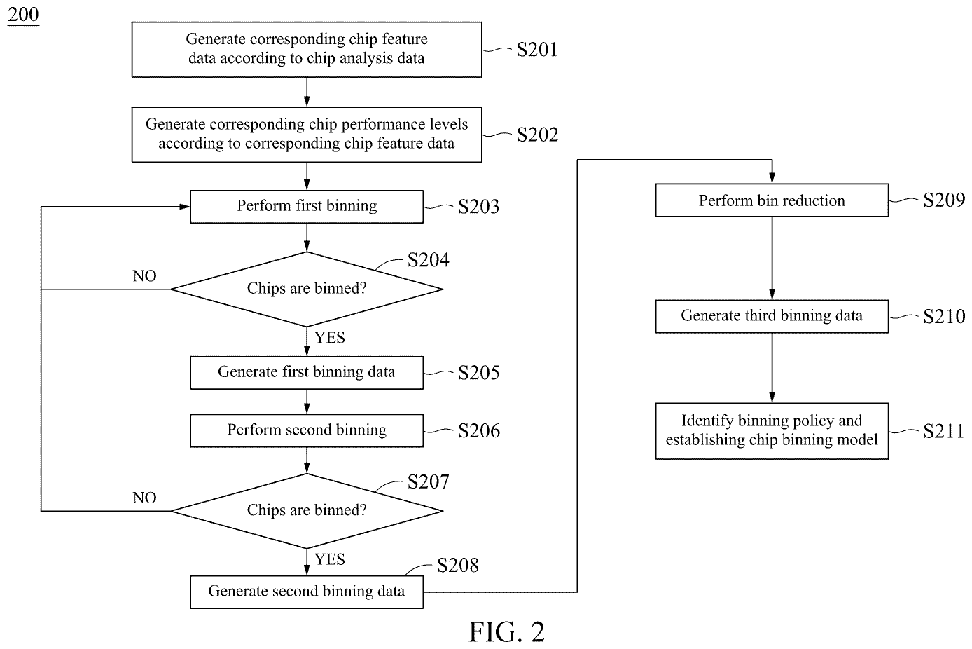

FIG. 1 is a schematic diagram of a chip binning system 100 in accordance with some embodiments of the present disclosure. As shown in FIG. 1, the chip binning system 100 includes a chip binning server 110, a binning analysis server 120, and a chip analysis database 130 which are communicatively connected to each other. The chip binning server 110 includes a feature generation module 111, a first binning module 112, a second binning module 113, and a bin reduction module 114. FIG. 2 is a flowchart of a chip binning method 200 in accordance with some embodiments of the present disclosure. Operations of the chip binning system 100 in the disclosure is described below with reference to FIGS. 1 and 2.

First, the chip binning server 110 receives chip analysis data from the chip analysis database 130, and Step S201 is performed, in which the feature generation module 111 of the chip binning server 110 generates corresponding chip feature data according to the chip analysis data. The chip analysis data may be one-dimensional or multi-dimensional data used or measured by a production line or a chip testing department and stored in the chip analysis database 130. The feature generation module 111 then performs data augmentation on the chip analysis data, which is to generate new chip feature data corresponding to each chip based on the correlation between different dimensions in the original chip analysis data and the importance of chip performance evaluation. After the new chip feature data is generated, the subsequent binning processes may be performed according to the chip feature data.

Specifically, the chip analysis data may include manufacturing parameters and sensing parameters (for example, preset and actual temperature, production speed of the production line) corresponding to each chip on the production line, and voltage, current, power, maximum frequency, speed, accuracy measured by the chip probe on the chip. Any parameter related to chip production and/or chip performance may be used as the chip analysis data and used for subsequent binning processes, which is not limited thereto. In addition, in one embodiment, the chip analysis data may be preprocessed before performing Step S201, for example, filtering to remove outliers to make the binning more accurate, and other data preprocessing may also be used, which is not limited thereto.

After the chip feature data is obtained, Step S202 is performed, in which the first binning module 112 generates corresponding chip performance levels according to the corresponding chip feature data, so as to perform a first binning according to the chip performance level corresponding to each chip. Besides the chip performance levels, other data intended for binning may also be generated according to the chip analysis data and/or the chip feature data, which is not limited thereto.

The chip performance levels may be obtained by calculating from the chip feature data corresponding to each chip, for example, by using a performance analysis model to comprehensively calculate the features of different dimensions in the chip feature data to give performance evaluation score or vector to each chip. Compared to directly using the chip analysis data to obtain chip performance levels, the chip feature data obtained after Step S201 may make the chip performance analysis and subsequent binning results closer to the quality target to be achieved in production. The chip performance levels may be obtained according to the chip analysis data and/or the chip feature data, and in such a case, the chip analysis data for use, the specific type of the chip feature data, and the algorithm or model used for chip performance calculation are not limited in the present disclosure.

After the chip performance level of each chip is obtained, Step S203 is performed, in which the first binning module 112 performs the first binning, that is, binning the chips according to the chip performance level corresponding to each chip. In one embodiment, the chips may be sorted according to the chip performance levels, and the chips with better chip performance levels and within a preset ratio, for example, the chips ranked in the top 5% of the chip performance levels, may be grouped into the same bin. In another embodiment, the chip performance distance between the chip performance level of each chip, such as the difference between values or the distance between vectors, may also be calculated to determine whether to group the chips into the same bin.

Specifically, one or more representative chips may be selected from the chips according to the chip performance levels, such as the chip with better performance level, as a binning center chip. With the chip performance level of the binning center chip as the center, the chip performance distances between the chip performance levels corresponding to other chips and the binning center chip may be calculated. A preset performance distance may be set to bin the chips whose chip performance distance to the binning center chip is smaller than the preset performance distance into the same bin. The preset performance distance may be estimated by referring to the preliminary binning results of other machine learning for the chips. The chips may be reasonably grouped according to the chip performance levels, and in such a case, the method for obtaining the preset chip distance is not limited in the present disclosure.

In one embodiment, the first binning may be performed to sort the chips with better performance levels within the preset ratio according to the chip performance ranking as described above first, and then sort the remaining chips according to the chip performance distances with the above manner in the first binning. For example, the top 5% of the chips in the chip performance ranking may be grouped into the same bin, and the remaining 95% of the chips may be sorted by selecting a binning center chip from them and binned according to the chip performance distances. In Step S204, the first binning module 112 determines whether the chips are binned to perform Step S205 to generate first binning data with the binning information corresponding to the binned chips (for example, chip serial numbers and labels indicating binning results). The chips that are not be binned, that is, cannot be binned into appropriate bins in the first binning, will be binned again in Step S203 with the chips that similarly cannot be binned in Step S207.

Next, after obtaining the first binning data, Step S206 is performed, and the second binning module 113 performs a second binning on the chips in each bin in the first binning data. Since using chip power has better discrimination for chip binning and is more related to the final chip specifications, in one embodiment, the second binning is performed according to the chip power level in the chip analysis data corresponding to the chips. However, the data or features may be used for the discrimination of the chip differences or specification requirements, and in such a case, it may be used as the binning basis for the second binning, which is not limited in the present disclosure.

The second binning is performed by binning according to the chip power levels. Specifically, the chips in each bin are divided into multiple sections according to the chip power levels, for example, divided into 100 sections or more, depending on the required level of precision. The section with the largest number of the chips is selected out as a binning section, and then the chip power level corresponding to this bin section is expanded outward, for example, to raise or lower the corresponding chip power level in half to one section, so that more chips may be included in the binning section. After changing the chip power level corresponding to the binning section each time, the power standard deviation of the chip power levels of the chips within the binning section is calculated. The expansion of the binning section and the calculation for the power standard deviation is repeated and when the power standard deviation is equal to or greater than a preset standard deviation, for example, the preset standard deviation is 0.25, it means that the second binning of this bin is completed, and the chips in the binning section with the largest number of chips and the power standard deviation equal to or less than the preset standard deviation are used as the binning result of the second binning of this bin. In other words, the second binning is performed on each bin in the first binning data to obtain the second binning result of each bin.

Since the same standard deviation has different degrees of looseness or strictness for data with different degrees of dispersion, the preset standard deviation is set according to the characteristics of the data. The setting of the preset standard deviation may be estimated by referring to the preliminary binning results of the chips using other clustering models. For example, K-means algorithm is used to perform the preliminary binning on the chips for determining the preset standard deviation accordingly. A reasonable chip power level range for such chip binning may be obtained, and in such a case, the method for determining the preset standard deviation is not limited in the present disclosure.

Next, Step S207 is performed, in which according to whether the chips have been binned in Step S206, the second binning module 113 performs Step S208 to generate the second binning data with the binning information corresponding to the binned chips (for example, chip serial numbers and labels indicating binning results). The chips that have not been binned, that is, are not included in the last binning section, are binned again in Step S203 together with the chips that have not been binned in the first binning. The first binning data and the second binning data may both be stored in the chip analysis database 130 for use when there is a subsequent analysis requirement.

After the chips pass through Steps S203 to S208, the second binning data includes the binning information related to the binned chips, and the re-binning is performed on the chips that have not been binned in Steps S204 and Step S207, and the first binning and the second binning are repeated from Step S203 again. In the re-binning stage, the chips may be binned directly according to the chip performance distance, and the preset performance distance of the first binning may be raised to be greater than that of the previous binning, that is, the condition for binning the chips into the same bin in the first binning of the re-binning is looser than that of the previous binning, so that the remaining chips may be successfully binned in the re-binning and the number of chips that cannot be binned is reduced. In one embodiment, the preset standard deviation in the second binning may also be raised to increase the number of chips in the same bin. In addition, the looseness of the first binning and the second binning in the re-binning stage may be adjusted according to the number or ratio of the chips to be retained and eliminated, which is not limited in the present disclosure.

After the second binning is completed, the number of bins obtained after the second binning may be large because all chips are binned as much as possible in the first binning and the second binning. Therefore, in one embodiment, after obtaining the second binning data, Step S209 may be performed subsequently, in which the bin reduction module 114 performs the bin reduction on the chips in the second binning data.

Specifically, according to the chip performance levels and the chip analysis data and/or chip feature data such as the chip power levels corresponding to the chips in the second binning data, it may use an unsupervised learning algorithm, such as a K-means algorithm, to reduce the numbers of the bins in the second binning data, so as to meet a preset number of bins, such as the number of bins required by a customer. Specifically, for example, the five bins with the best average chip performance level are combined into one bin, and the five bins with the second best average chip performance level are combined into one bin. The number of bins may be reduced, and in such a case, the reduction may also be based on, for example, the maximum power level of the chips, the average chip performance level or the cumulative chip performance level. The reduction method, the reduced number of bins, and the chip analysis data or chip feature data on which it is based are not limited in the present disclosure.

After the bin reduction module 114 performs the bin reduction on the chips in the second binning data, Step S210 is performed to generate third binning data. The third binning data includes the binning information corresponding to the binned chips (for example, chip serial numbers and labels indicating binning results), and the number of the bins in the third binning data is less than that of the first binning data and the second binning data. Furthermore, the third binning data may also be stored in the chip analysis database 130 for use when there is a subsequent analysis requirement.

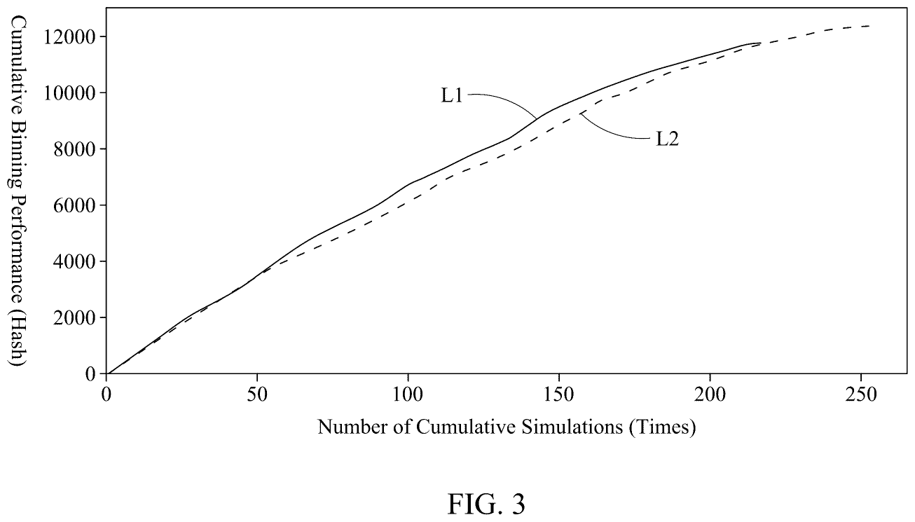

FIG. 3 is a schematic diagram of a binning performance comparison of the chip binning method 200 and K-means algorithm in accordance with some embodiments of the present disclosure. Here, taking binning into 30 bins as an example, the solid line L1 is the cumulative binning performance under multiple simulations of using Step S201 to Step S210 in the chip binning method 200 to bin the chips into 30 bins, that is, completing the binning reduction and binning the chips into 30 bins. The dotted line L2 is the cumulative binning performance under multiple simulations of binning the chips into 30 bins based on the chip analysis data directly, using K-means algorithm based on the chip performance data and the chip power levels. As shown in FIG. 3, when the number of simulations increases, the chip binning method 200 has better binning performance. In addition, the number of bins applicable to the chip binning method 200 is not limited thereto, that is, the chip binning method 200 may obtain better binning performance under different numbers of bins compared to K-means algorithm.

In addition, in one embodiment, since the chips may have the same binning requirements for each batch during multiple productions, in order to raise binning efficiency, the third binning data and the chip analysis data and/or the chip feature data, and the labels of the binning results corresponding to the included chips may be analyzed to obtain a binning policy, which may be applied to subsequent batches of chips for quick binning. Therefore, as shown in FIG. 2, Step S211 may be performed subsequently, in which the binning analysis server 120 directly obtains the third binning data and the corresponding chip analysis data and/or chip feature data from the chip binning server 110 or the chip analysis database 130, and then uses a supervised learning model, such as a random forest, a support vector machine, or an artificial neural network, to identify the binning policy implicit in the third binning data and establish a chip binning model. The trained chip binning model may be used for quick binning on subsequent batches of chips. Specifically, the chip binning model may be used for quick binning on subsequent batches of chips to generate fourth binning data, that is, the fourth binning data includes the correspondence between each chip in this batch and each bin in the third binning data, so as to obtain which bin in the corresponding third binning data each chip may be binned into, and label each chip in this batch with the corresponding bin number.

The chip binning system and method in the disclosure filters the chip analysis data and augments the chip feature data for binning by data augmentation. The first binning and the second binning are then performed for two-stage binning according to the chip performance levels and the chip power levels. The number of bins is ultimately reduced to make the binning results more refined and meet the binning number requirements. Compared to using only clustering algorithms such as K-means algorithm, the chip binning system and method may fully consider the impact of the chip power and distinguish the chips with slight differences to obtain more accurate binning results.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A chip binning system, comprising:
a chip analysis database configured to store chip analysis data corresponding to chips, and
a chip binning server communicatively connected to the chip analysis database to receive the chip analysis data, the chip binning server comprising:
a feature generation module configured to generate corresponding chip feature data according to the chip analysis data;
a first binning module configured to generate corresponding chip performance levels according to the corresponding chip feature data, and perform a first binning on the chips according to the chip performance levels to generate first binning data;
a second binning module configured to perform a second binning on the chips in each bin in the first binning data according to corresponding chip power levels in the chip analysis data to generate second binning data; and
a bin reduction module configured to perform a binning reduction on a number of bins in the second bin data to generate third binning data.

2. The chip binning system of claim 1, wherein the first binning module is further configured to perform a re-binning on the chips not binned by the first binning and the second binning.

3. The chip binning system of claim 1, further comprising:
a binning analysis server communicatively connected to the chip binning server and configured to receive the third binning data and the chip analysis data corresponding to the chips in the third binning data for building a chip binning model accordingly;
wherein the chip binning model is used for binning other chips different from the chips according to the corresponding chip analysis data to generate fourth binning data.

4. The chip binning system of claim 3, wherein each of the other chips in the fourth data corresponding to at least one of bins in the third binning data.

5. The chip binning system of claim 1, wherein the first binning is to bin a preset ratio of the chips with better chip performance levels according to the corresponding chip performance levels, and generate the first binning data.

6. The chip binning system of claim 1, wherein the first binning is to select at least one binning center chip from the chips according to the corresponding chip performance levels, bin the chips according to whether chip performance distances between the chips and the at least one binning center chip are smaller than a preset performance distance, and generate the first binning data.

7. The chip binning system of claim 6, wherein the first binning module is further configured to perform a re-binning on the chips not binned by the first binning and the second binning, and the preset performance distance in the re-binning is greater than the previous binning.

8. The chip binning system of claim 1, wherein in the second binning data generated by the second binning module, a power standard deviation of the chips in each bin is smaller or equal to a preset standard deviation.

9. A chip binning method, comprising:
generating corresponding chip feature data according to chip analysis data corresponding to chips;
generating corresponding chip performance levels according to the corresponding chip feature data, and performing a first binning on the chips according to the chip performance levels to generate first binning data;
performing a second binning on the chips in each bin in the first binning data according to corresponding chip power levels in the chip analysis data to generate second binning data; and
performing a binning reduction on a number of bins in the second bin data to generate third binning data.

10. The chip binning method of claim 9, further comprising:
performing a re-binning on the chips not binned by the first binning and the second binning.

11. The chip binning method of claim 9, further comprising:
building a chip binning model according to the third binning data and the chip analysis data corresponding to the chips in the third binning data;
wherein the chip binning model is used for binning other chips different from the chips according to the corresponding chip analysis data to generate fourth binning data.

12. The chip binning method of claim 11, wherein each of the other chips in the fourth data corresponding to at least one of bins in the third binning data.

13. The chip binning method of claim 9, wherein the first binning is to bin a preset ratio of the chips with better chip performance levels according to the corresponding chip performance levels, and generate the first binning data.

14. The chip binning method of claim 9, wherein the first binning is to select at least one bin center chip from the chips according to the corresponding chip performance levels, bin the chips according to whether chip performance distances between the chips and the at least one bin center chip are smaller than a preset performance distance, and generate the first binning data.

15. The chip binning method of claim 14, further comprising:
performing a re-binning on the chips not binned by the first binning and the second binning, and the preset performance distance in the re-binning is greater than the previous binning.

16. The chip binning method of claim 9, wherein in the second binning data generated by the second binning, a power standard deviation of the chips in each bin is smaller or equal to a preset standard deviation.
